(19) United States
(12) Patent Application Publication
(10) Pub. No.: US 2018/0218256 A1
(43) Pub. Date: Aug. 2, 2018

(54) DEEP CONVOLUTION NEURAL NETWORK BEHAVIOR GENERATOR

(71) Applicant: QUALCOMM Incorporated, San Diego, CA (US)

(72) Inventors: Dolev RAVIV, Kiryat Yam (IL); Ofer ROSENBERG, Ramot Menashe (IL); Lee SUSMAN, Pardesia (IL)

(21) Appl. No.: 15/422,938

(22) Filed: Feb. 2, 2017

(51) Int. Cl. G06N 3/04; G06N 3/08

(52) U.S. Cl. CPC G06N 3/0472; G06N 3/08

(57) ABSTRACT

A method for generating synthetic behavior samples with a behavior generator includes drawing, at the behavior generator, a vector from a probability distribution obtained from behavior data of a plurality of users. The method also includes generating, with an artificial neural network decoder of the behavior generator, a synthetic behavior sample based on the vector. The method further includes tuning a model, which identifies a device user, using the generated synthetic behavior sample.

### BACKGROUND

### Field

Certain aspects of the present disclosure generally relate to machine learning and, more particularly, to improving systems and methods of generating behavior samples for training and/or tuning a neural network that identifies a user based on behavior samples.

### Background

Generally, a device is authenticated using a password. In some cases, biometric data, such as a fingerprint or retinal scan, may be used to authenticate a device. In other cases, behavior data may be used to authenticate a device.

Behavior data may include one or more samples from different sensors on a mobile device, such as a voice sensor, touch sensor, accelerometer, and/or gyroscope. A device, such as a mobile device, may include a neural network (e.g., machine learning component) for authenticating a user based on behavior samples obtained from sensors of the device. That is, the neural network may classify the user based on the extracted features. The neural network may be a convolutional neural network (CNN), such as a deep convolutional neural network, which learns connections between consecutive samples to predict the user based on the extracted features.

A convolutional neural network refers to a type of feed-forward artificial neural network. A neural network, such as an artificial neural network, with an interconnected group of artificial neurons (e.g., neuron models) may be a computational device or may be a method to be performed by a computational device. Convolutional neural networks may include collections of neurons, each neuron having a receptive field and also collectively tiling an input space.

To perform an accurate classification (e.g., authentication of a user) the convolutional neural network should be initially trained and/or tuned, after the initial training, with training data. The training data may include positive samples and negative samples. For behavior classification, the positive behavior samples may be obtained from behavior data generated from a device user's behavior (e.g., interaction with the device). The negative behavior samples may be obtained from other users. In conventional systems, a large number of negative behavior samples (e.g., training data) are stored on a device for the initial training and/or tuning of a neural network.

For some devices, such as a mobile device, resources are limited, such that the device may not have the capability to store the training data needed to initially train and/or tune the neural network. In conventional systems, to mitigate the need to store a large amount of training data, the system may use a data connection to transfer batches of training data. Using the data connection to transfer batches of training data may increase the use of bandwidth and may also increase costs to maintain a server for transferring the training data.

Other conventional systems use a hybrid approach, where the training is performed on a remote device, such as a cloud device, and the trained neural network is transmitted to the user device (e.g., mobile device) via a data connection. That is, in the hybrid approach, positive samples are obtained at the user device and sent to the remote device. The neural network is trained at the remote device using the received positive samples as well as negative samples stored at the remote device. The hybrid approach may not be desirable as the privacy of the user may be compromised when the positive samples are transmitted to the remote device. In addition, the transmission of both the positive samples and the trained neural network consumes bandwidth.

The solutions presented in conventional systems increase the amount of training data stored on a device, increase the bandwidth used by a device, and/or raise privacy concerns. It is desirable to generate negative behavior samples on the device to mitigate the aforementioned issues of conventional systems. Aspects of the present disclosure are directed to generating negative behavior samples on demand, such as when the convolutional neural network is trained (e.g., tuned).

### SUMMARY

In one aspect of the present disclosure, a method for generating synthetic behavior samples with a behavior generator is disclosed. The method includes drawing, at the behavior generator, a vector from a probability distribution obtained from behavior data of a plurality of users. The method also includes generating, with an artificial neural network decoder of the behavior generator, a synthetic behavior sample based on the vector. The method further includes tuning a model, which identifies a device user, using the generated synthetic behavior sample.

Another aspect of the present disclosure is directed to an apparatus for generating synthetic behavior samples with a behavior generator. The apparatus including means for drawing, at a behavior generator, a vector from a probability distribution obtained from behavior data of a plurality of users. The apparatus also includes means for generating, with an artificial neural network decoder of the behavior generator, a synthetic behavior sample based on the vector. The apparatus further includes means for tuning a model, which identifies a device user, using the generated synthetic behavior sample.

In another aspect of the present disclosure, a non-transitory computer-readable medium with non-transitory program code recorded thereon is disclosed. The program code for generating synthetic behavior samples with a behavior generator is executed by a processor and includes program code to draw, at a behavior generator, a vector from a probability distribution obtained from behavior data of a plurality of users. The program code also includes program code to generate, with an artificial neural network decoder of the behavior generator, a synthetic behavior sample based on the vector. The program code further includes program code tune a model, which identifies a device user, using the generated synthetic behavior sample.

Another aspect of the present disclosure is directed to a behavior generator for generating synthetic behavior samples, the behavior generator having a memory unit and one or more processors coupled to the memory unit. The processor(s) is configured to draw a vector from a probability distribution obtained from behavior data of a plurality of users. The processor(s) is also configured to generate, with an artificial neural network decoder of the behavior generator, a synthetic behavior sample based on the vector. The processor(s) is further configured to tune a model, which identifies a device user, using the generated synthetic behavior sample.

In one aspect of the present disclosure, a method of training an artificial neural network to generate synthetic behavior samples is disclosed. The method includes training, a convolutional auto encoder of the artificial neural network, to generate a representation of an original behavior sample received from behavior data of a plurality of users. The method also includes estimating, after training the convolutional auto encoder, a per-user distribution and a distribution of all users of the plurality of users for each original behavior sample of the behavior data. The method further includes combining the distribution of all users to determine a probability distribution of the behavior data.

Another aspect of the present disclosure is directed to an apparatus including means for training, a convolutional auto encoder of the artificial neural network, to generate a representation of an original behavior sample received from behavior data of a plurality of users. The apparatus also includes means for estimating, after training the convolutional auto encoder, a per-user distribution and a distribution of all users of the plurality of users for each original behavior sample of the behavior data. The apparatus further includes means for combining the distribution of all users to determine a probability distribution of the behavior data.

In another aspect of the present disclosure, a non-transitory computer-readable medium with non-transitory program code recorded thereon is disclosed. The program code for training an artificial neural network to generate synthetic behavior samples is executed by a processor and includes program code to train, a convolutional auto encoder of the artificial neural network, to generate a representation of an original behavior sample received from behavior data of a plurality of users. The program code also includes program code to estimate, after training the convolutional auto encoder, a per-user distribution and a distribution of all users of the plurality of users for each original behavior sample of the behavior data. The program code further includes program code combine the distribution of all users to determine a probability distribution of the behavior data.

Another aspect of the present disclosure is directed to an artificial neural network for generating synthetic behavior samples, the artificial neural network having a memory unit and one or more processors coupled to the memory unit. The processor(s) is configured to train, a convolutional auto encoder of the artificial neural network, to generate a representation of an original behavior sample received from behavior data of a plurality of users. The processor(s) is also configured to estimate, after training the convolutional auto encoder, a per-user distribution and a distribution of all users of the plurality of users for each original behavior sample of the behavior data. The processor(s) is further configured to combine the distribution of all users to determine a probability distribution of the behavior data.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a diagram illustrating a neural network according to aspects of the present disclosure.

FIG. 5 is a diagram illustrating a behavior generator according to aspects of the present disclosure.

FIG. 6 illustrates a flow diagram for a method of generating synthetic behavior samples with a behavior generator according to aspects of the present disclosure.

FIG. 7 illustrates a flow diagram for a method of training an artificial neural network to generate synthetic behavior samples according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

For security, as well as other reasons, it is desirable to authenticate a user of a mobile device. Authentication may be used to unlock the mobile device. Furthermore, while the device is unlocked, the mobile device may also authenticate the user to maintain the unlocked state and/or to provide access to various applications and/or data. For example, during operation, the mobile device may authenticate the current user to allow continued access to applications designated for the current user. If a user is not authenticated, access to one or more applications may be denied. Additionally, while a device is unlocked, the operator may change from a first user to a second user. In one configuration, based on the behavior data, the mobile device determines that the operator has changed from the first user to the second user. In response to the detected operator change, the mobile device adjusts the access according to the account (e.g., device) permissions granted to the second user.

The behavior data may be gathered from multiple sensors and the gathering of behavior data may be implicit to the user. That is, an explicit user response is not compelled during the authentication process. Rather, the authentication is seamlessly performed during the user's normal use of the device. For example, the behavior data collection may include the force of a touch on a touch screen, the length of the touch, the orientation of the phone, the time of use, and/or currently running applications. The seamless authentication decision may be based on the union of all sensor inputs, including the correlations between different behavior components.

A convolutional neural network, such as a deep convolutional neural network, may be used to authenticate the user. The convolutional neural network should be trained on positive behavior samples of the user and negative behavior samples. The training may be an initial training and/or a tuning of the convolutional neural network after an initial training. In conventional systems, a large number of negative behavior samples are stored on the device to be used during training (e.g., tuning). Aspects of the present disclosure are directed to generating synthetic behavior samples as needed during training. That is, in contrast to conventional systems, a device of the present configuration does not store or receive negative behavior samples for training. Rather, the generated synthetic behavior samples may be used as negative behavior samples for training.

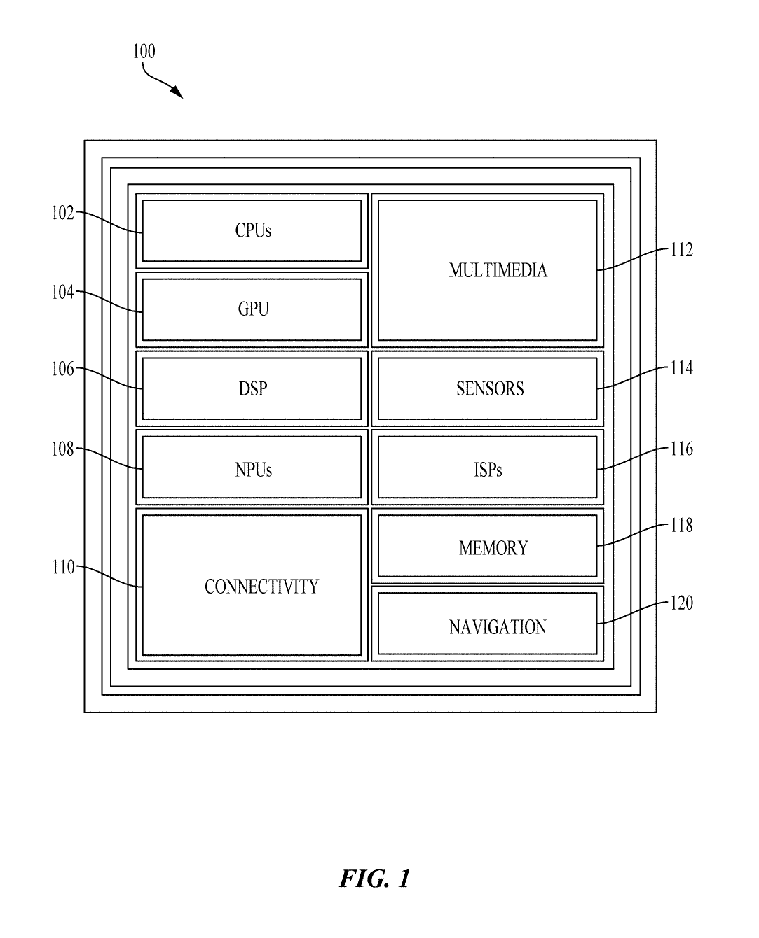

FIG. 1 illustrates an example implementation of the aforementioned synthetic behavior sample generation using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation 120, which may include a global positioning system.

The SOC 100 may be based on an ARM instruction set. In an aspect of the present disclosure, the instructions loaded into the general-purpose processor 102 may comprise code to draw, at the behavior generator, a vector from a probability distribution obtained from behavior data of multiple users. The instructions loaded into the general-purpose processor 102 may also comprise code to generate, with an artificial neural network decoder of the behavior generator, a synthetic behavior sample based on the vector. The instructions loaded into the general-purpose processor 102 may further comprise code to tune a model, which identifies a device user, using the generated synthetic behavior sample.

In another aspect of the present disclosure, the instructions loaded into the general-purpose processor 102 may comprise code to train a convolutional auto encoder of the artificial neural network to generate a representation of an original behavior sample received from behavior data of multiple users. The instructions loaded into the general-purpose processor 102 may also comprise code to estimate, after training the convolutional auto encoder, a per-user distribution and a distribution of all users of the multiple users for each original behavior sample of the behavior data. The instructions loaded into the general-purpose processor 102 may further comprise code to combine the distribution of all users to determine a probability distribution of the behavior data.

Aspects of the present disclosure are not limited to the general-purpose processor 102 performing the aforementioned functions. The code may also be executed via the CPU, DSP, GPU, and/or any other type of processor.

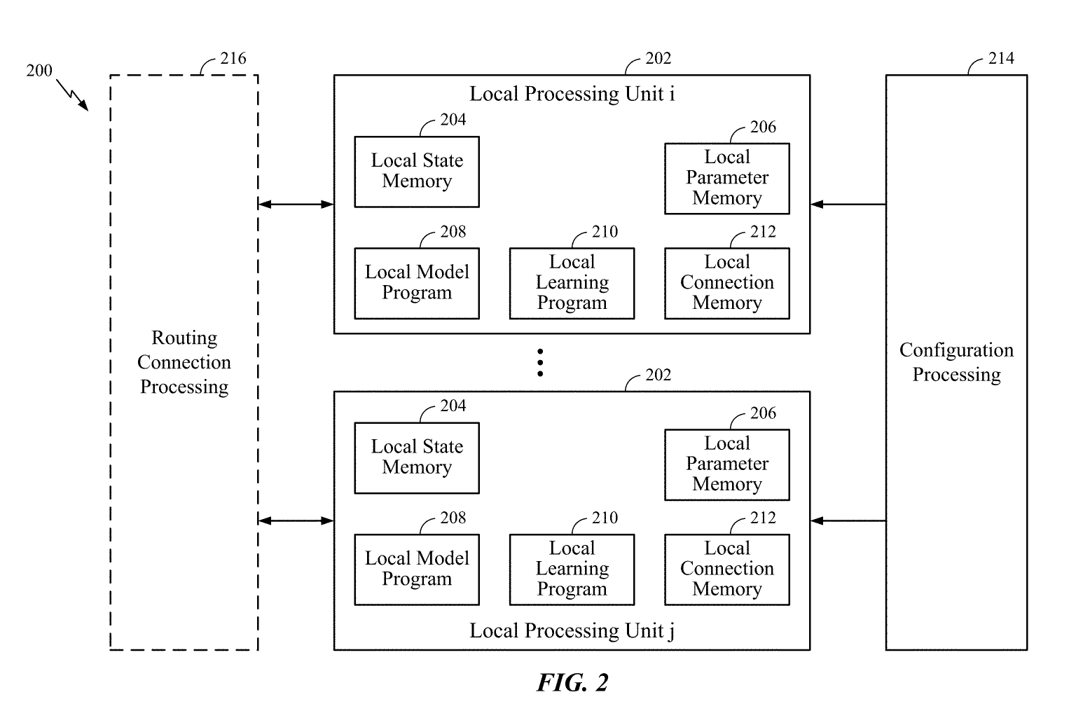

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

In one configuration, a processing model is configured for drawing, at the behavior generator, a vector from a probability distribution obtained from behavior data of multiple users. The model is also configured for estimating, after training the convolutional auto encoder, a per-user distribution and a distribution of all users of the multiple users for each original behavior sample of the behavior data. The model is further configured for tuning a model, which identifies a device user, using the generated synthetic behavior sample. The model includes generating means, drawing means, and/or tuning means.

In one configuration, a processing model is configured for training a convolutional auto encoder of the artificial neural network to generate a representation of an original behavior sample received from behavior data of multiple users. The model is also configured for generating, with an artificial neural network decoder of the behavior generator, a synthetic behavior sample based on the vector. The model is further configured for combining the distribution of all users to determine a probability distribution of the behavior data. The model includes training means, generating means, and/or combining means.

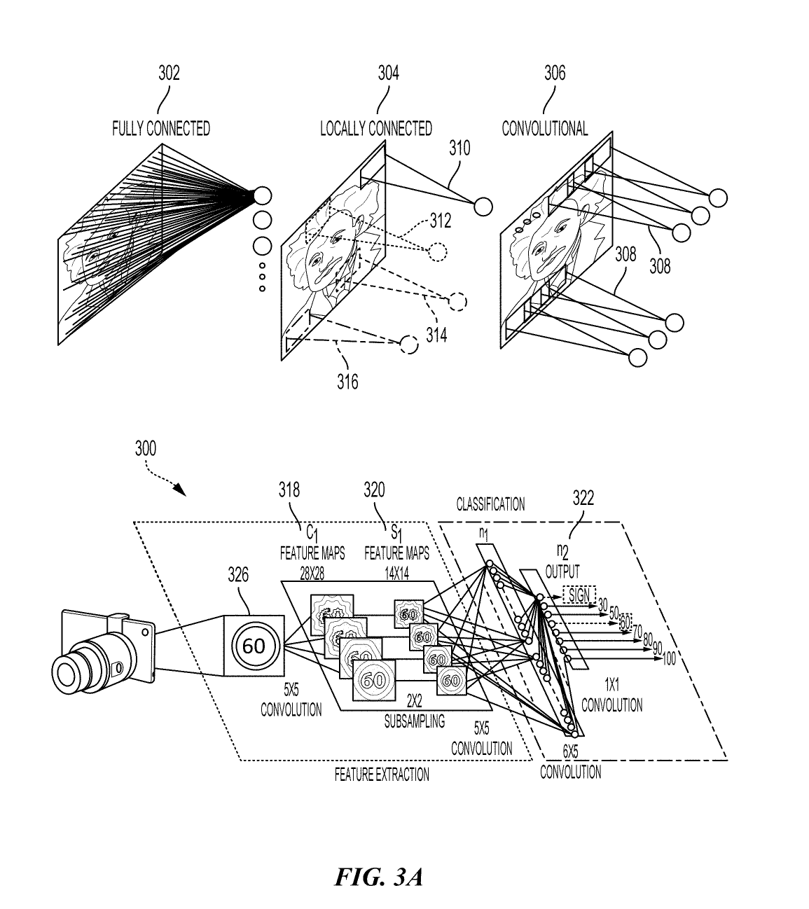

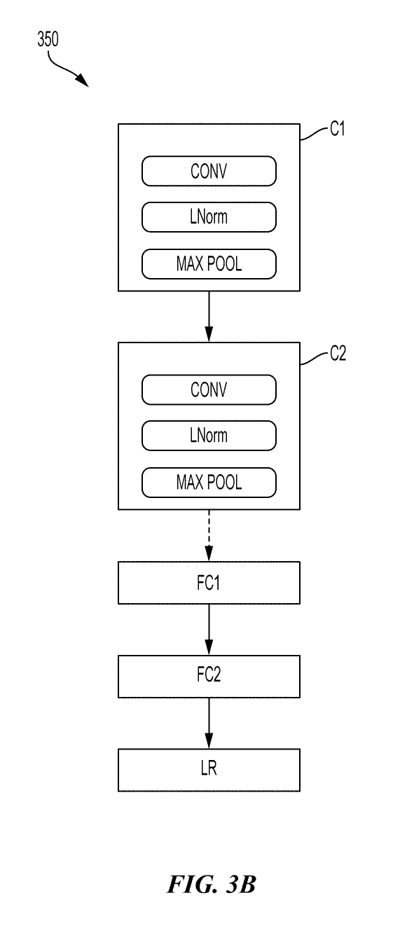

In one configuration, the generating means, drawing means, tuning means, training means, and/or combining means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

[Inventors: the following non-highlighted section is background information for neural networks. We modified the text based on your previous comments to show that a 1D signal may be used in FIG. 3A]

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with a signal, such as a cropped image of a speed limit sign 326, and a “forward pass” may then be computed to produce an output 322. The signal may include one-dimensional behavior samples. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template, a temporally invariant template, or a basis projection. The input may be decomposed into multiple channels. For example, each channel may represent a color, such as the red, green, and blue channels of a color image. As another example, each channel may include a sample from a sensor, such as a touch sensor, global positioning system (GPS) sensor, rotation sensor, and/or pressure sensor. A convolutional network trained on a color input may be considered three-dimensional, with two spatial dimensions along the axes of the image and a third dimension capturing color information. When receiving a sample from a sensor, such as a touch sensor, the convolutional network trained on that input may be considered temporal. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

FIG. 3A illustrates an example of a two-dimensional (2D) convolutional neural network. Aspects of the present disclosure are not limited to the 2D convolutional neural network of FIG. 3A as other types of convolutional neural networks, such as a one-dimensional convolutional neural network, are also contemplated. Moreover, although a single sensor (e.g., camera) is shown, each of multiple sensors may input into a one-dimensional convolutional neural network, as discussed in more detail below.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. The deep convolutional network 350 may also use batch normalization layers, shortcuts between layers, and splits in a network graph. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

### Convolutional Neural Network Behavior Generator

As discussed above, aspects of the present disclosure are directed to generating negative behavior samples on demand, such as when a convolutional neural network is initially trained and/or tuned. The convolutional neural network may be referred to as a neural network or an artificial neural network. In one configuration, a neural network, such as a deep convolutional neural network, is trained on a remote device to generate negative samples of behavior data. The generated negative samples may be referred to as generated synthetic behavior samples. The remote device may be an external server or a cloud device.

The neural network used for generating negative behavior samples may include a feature extractor that projects to a higher dimensional space and a convolution auto encoder (CAE) that compresses a representation. The convolutional auto encoder may include an encoding portion and a decoding portion. A bottleneck may be specified between the encoding portion and the decoding portion. The bottleneck receives the encoded output of the encoding portion. According to aspects of the present disclosure, the bottleneck and decoding portion may be referred to as a behavior generator.

In one configuration, a neural network, such as the convolutional auto encoder, that includes a behavior generator is trained using aligned and interpolated behavior samples obtained from behavior data. In this configuration, the neural network receives behavior data from different users and samples from the behavior data are input to a convolutional auto encoder that compresses a representation of an input sample (e.g., original behavior sample vector) and outputs a representation of the input sample (e.g., decoded behavior sample vector). It is desirable for the output representation to be substantially similar to the input sample. The convolutional auto encoder may be trained, via back propagation, to generate output representations that are substantially similar to the input sample. In one configuration, the convolutional auto encoder of a neural network is trained to generate a representation of an original behavior sample received from behavior data of a multiple different users. After training, the behavior generator is deployed in the mobile device, so that the mobile device may generate a synthetic behavior sample by drawing (e.g., generating) a user vector from the distribution.

According to an aspect of the present disclosure, during training, a mean of the samples of each uses is calculated. The mean is used to estimate the user distribution. Additionally, all samples are normalized by reducing the mean of each user. Finally, a distribution of all the normalized samples is calculated. The distributions may be deployed on a mobile device so that a normalized sample may be drawn from the distributions. A user (e.g., fake user) may be drawn from the normalized sample and the normalized sample is shifted with the user center. For varying length samples, the length distribution may be estimated. Alternatively, a random hidden markov process may be used for varying length samples.

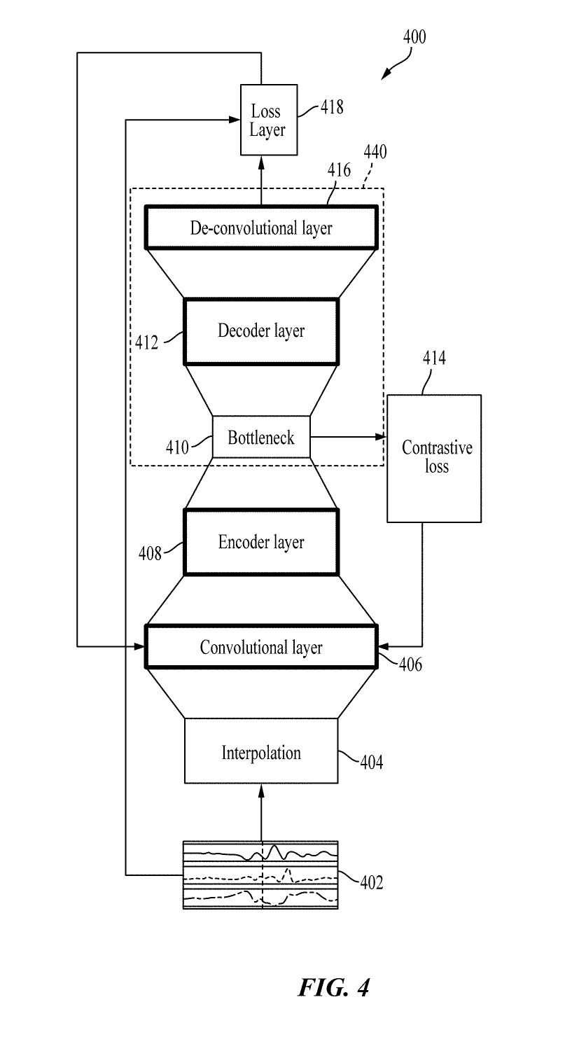

FIG. 4 illustrates an example of a neural network 400 that includes a behavior generator according to an aspect of the present disclosure. As shown in FIG. 4, the neural network 400 receives behavior data 402 from different users. Behavior data 402 corresponds to information, such as a user gesture, obtained via a sensor on the mobile device. The behavior data 402 may comprise a sequence of different samples from multiple sensors of different users. Each sensor may be sampled independently in multiple different time intervals, resulting in a multichannel time series. The sequence of samples may be referred to as a sequence of multi-dimensional time based samples (one dimension for each sensor). Time based samples refer to samples received from the sensor at a given time. Each sensor provides data at its own rate, which may be different from the rate of other sensors. Therefore, each sensor generates a different number of samples at different times.

The input size of a neural network, such as a convolutional neural network or a deep neural network, is fixed. In one configuration, the samples are vectors (e.g., tensors) that are adjusted to a pre-determined size and/or frequency. A sample that is missing data points may be compensated by interpolation and extrapolation at an interpolation layer 404. The interpolation and extrapolation may create missing data points in a sample such that the all samples have the same size (e.g., same number of data points). Furthermore, gestures having a length (e.g., number of samples) that is greater than the fixed size may be sub-sampled or discarded. That is, after the interpolation and extrapolation, each sample may be represented as a vector having the same number of data points.

After aligning the samples at the interpolation layer 404, one of the aligned samples (e.g., original behavior sample vectors) is selected and input to a convolutional layer 406. That is, the interpolation layer 404 projects one sample to a higher dimensional space (e.g., convolutional layer 406). The convolutional layer 406 convolves the samples and outputs the convolved sample to an encoder layer 408. The encoder layer 408 outputs an encoded representation (e.g., compressed vector or encoded vector) of an original behavior sample vector, obtained from the behavior data 402, to a bottleneck layer 410. That is, the convolutional layer 406 and the encoder layer 408 generate a compressed sample that is received at the bottleneck layer 410, such that a compressed vector from the encoder layer 408 is smaller than an original behavior sample vector that is input to the convolutional layer 406. The bottleneck layer 410 may be referred to as an embedding space. At the bottleneck layer 410, after training is complete, the vector representation is transmitted to a contrastive loss layer 414 that uses a contrastive loss function to estimate inter-user variance and across user variance. The contrastive loss layer 414 may be included in the bottleneck layer 410 or may be a separate layer.

Deep neural networks may be trained using batches of data (e.g., stochastic gradient descend (SGD)). The forward and back passes for training are performed across all samples in the batch. The batch may be used to improve the time for training. In one configuration, the contrastive loss layer 414 uses a pair of samples from the batch to estimate inter-user variance and across user variance. Additionally, the loss layer 418 determines the loss independently for each sample in the batch.

One objective of the training is to improve the accuracy of the behavior generator. Another objective of the training is to use the trained convolutional auto encoder and bottleneck to determine a probability distribution of each user. In one configuration, an embedding of original behavior sample vectors (e.g., user behavior samples) is learned by the neural network. The learned embedding may capture the vector distribution and the encoded distribution. The probability distribution is learned (e.g., estimated) from the embedding space (e.g., bottleneck layer 410).

The contrastive loss layer 414 generates clusters for each user based on the encoded representation. That is, the contrastive loss layer 414 generates multiple clusters (e.g., one cluster for each user) in the encoded space from samples generated by the different users. By generating multiple clusters in the encoded space from samples generated by different users, the neural network estimates a per-user distribution and also estimates a distribution across all users. In one configuration, the neural network estimates how the clusters are distributed in space (e.g., distribution across all users) and the distribution within each cluster (e.g., per-user distribution). Estimating the per-user distribution and the distribution across all users results in more accurate synthetic data generation when the behavior generator is deployed on a mobile device. The estimation per user is separately determined and combined after all of the user distributions are determined.

The bottleneck layer 410 also outputs the encoded representation (e.g., compressed vector) to a decoder layer 412. The decoder layer 412 decodes the vector representation and transmits the decoded representation (e.g., decoded vector) to a de-convolutional layer 416. An output representation is generated by the de-convolutional layer 416. The output representation may be referred to as a de-compressed sample vector. It is desirable for the output representation to resemble the original representation. Thus, the de-convolutional layer 416 outputs the output representation to a loss layer 418 that compares the output representation to the original representation to determine a loss value. In one configuration, a loss layer 418 compares the output sample vector to the input sample vector using a loss function, such as mean square error (L2), to obtain a loss value. The loss value is back propagated to update the convolutional auto encoder to improve accuracy.

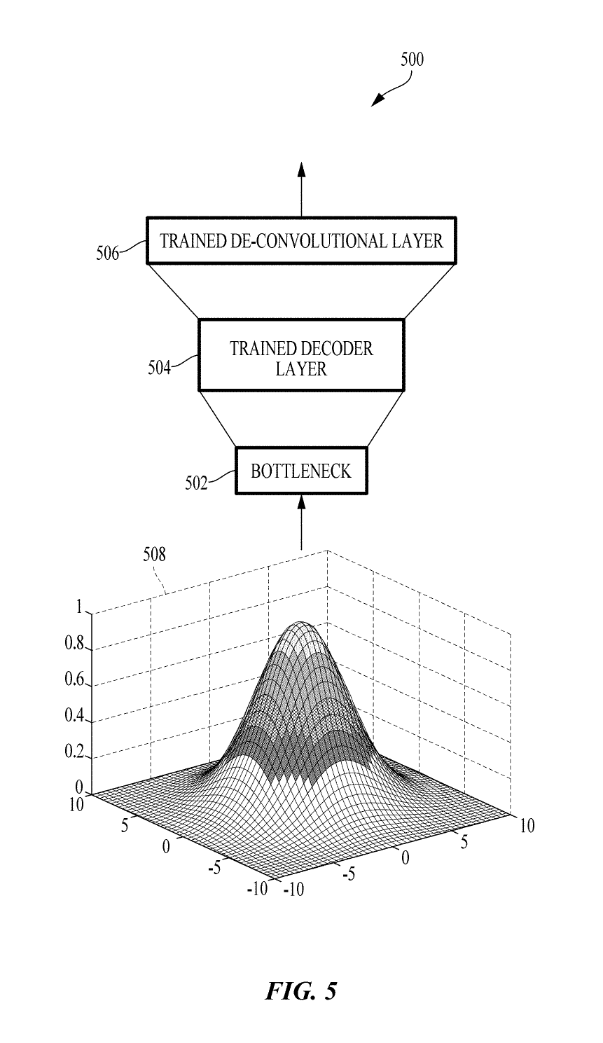

As previously discussed, the neural network 400 may include a feature extractor (e.g., convolutional layer 406) followed by a convolution auto encoder. The feature extractor may be extracted using transfer learning from a convolutional neural network trained to distinguish users. In one configuration, the convolutional layer 406, encoder layer 408, decoder layer 412, and de-convolutional layer 416 are components of a convolutional auto encoder. The layers of the neural network 400 (e.g., convolution, pooling, de-convolution, de-pooling, batch normalization, and activation) may be dimension ignorant layers. FIGS. 4 and 5, as well as the related description, provide examples of a neural network with a convolutional layer, an encoder layer, a decoder layer, and a de-convolutional layer. Of course, other layers are also contemplated for the neural network and the neural network is not limited to the convolutional layer, the encoder layer, the decoder layer, and the de-convolutional layer. Moreover, the convolutional and encoder layers may be combined. Also, the decoder and de-convolutional layers can be combined.

After the training is performed using all of the behavior data 402, a probability distribution of the behavior data 402 is captured. That is, after the training is complete, each of the samples from the behavior data 402 is input one at a time to the neural network 400. The bottleneck layer 410 holds the encoded vector which is the computation result of the encoder layer 408. As an example, the neural network 400 records the intermediate buffer of the bottleneck layer 410 to determine how the bottleneck layer 410 encodes each vector. The neural network 400 estimates the per-user distribution and the distribution across all users one at a time for each sample. A combined per-user distribution and a combined distribution across all users are determined after all of the samples have been processed. In one configuration, the per-user distribution and the distribution across all users are estimated with an increased weight on sample length, sequence start, and sequence endings.

As an example, after being processed by the interpolation layer 404, a sample of a user may be represented by a ten sample vector. The ten sample vector may processed by the convolutional layer 406 and the encoder layer 408 to generate a compressed representation, which is output to the bottleneck layer 410. The bottleneck layer 410 includes a contrastive loss layer 414, which clusters the compressed representation for the user to determine a per-user distribution and a distribution across all users. In one configuration, each compressed representation of a user is clustered closer together than compressed representations of different users. The size of the compressed representation is a function of the sample length, which may be determined by the interpolation layer 404. The size of the compressed representation may vary. Additionally, the size of the compressed representation may be less than the size of the sample vector. The process of clustering the compressed representation for the user to determine a per-user distribution and a distribution across all users is repeated for all samples.

After training and determining the probability distribution, the interpolation layer 404, the convolutional layer 406, and the encoder layer 408 may be removed from the neural network 400 such that a behavior generator 440 remains. The behavior generator 440 includes the bottleneck layer 410, the trained decoder layer 412, and the trained de-convolutional layer 416. Furthermore, after training is complete and prior to estimating the probability distribution across all users one at a time for each sample, the loss layer 418 and the contrastive loss layer 414 may be removed.

FIG. 5 illustrates an example of a behavior generator 500 deployed on a mobile device according to an aspect of the present disclosure. As shown in FIG. 5, the behavior generator 500 includes a neural network that includes a bottleneck layer 502, a trained decoder layer 504, and a trained de-convolutional layer 506. Additionally, the behavior generator 500 includes a probability distribution 508 (e.g., user sample distribution). The probability distribution 508 may be obtained from an embedded space of behavior data of multiple users after training a convolutional auto encoder on a remote device.

The per-user distribution and the distribution across all users may be deployed on the mobile device. On the mobile device, a random user is drawn from the distributions. The length of the vector may also be drawn. Given the user a random sample is drawn for that user. That is, the embedded space has a multimodal distribution (e.g., number of modal matches the number of users) such that the draw is a draw from a multimodal distribution. In one configuration, the normal distribution is estimated on the modals centers. The modals may have a similar distribution.

In one configuration, a positive behavior sample is obtained from the user's interaction with a mobile device. To initially train and/or tune the neural network specified for classifying the user, one or more negative behavior samples should be used with the positive behavior sample. To generate one or more negative behavior samples, the behavior generator 500 draws a vector from a probability distribution 508. The drawn vector may be a representation of encoded behavior samples of a user that is different from the user of the mobile device. For example, the behavior generator 500 draws an eight number vector from the probability distribution 508. The eight number vector is input to the bottleneck layer 502 and further processed by the trained decoder layer 504 and a trained de-convolutional layer 506 to generate a negative behavior sample (e.g., synthetic behavior sample) based on the drawn vector.

The negative behavior samples may be used with the user's samples (e.g., positive samples) during a training and/or tuning phase of a neural network specified for authenticating a user. The behavior generator of the mobile device may be referred to as the deployed behavior generator.

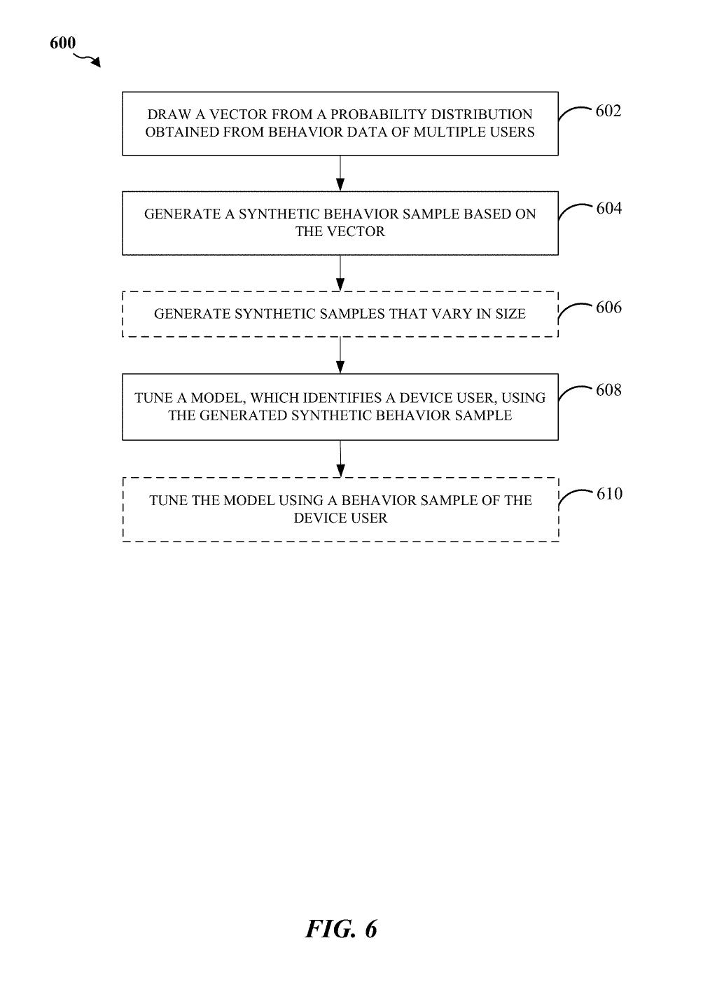

FIG. 6 illustrates a method 600 for generating synthetic behavior samples with a behavior generator. At block 602, the behavior generator draws a vector from a probability distribution obtained from behavior data of multiple users. The drawn vector may be a representation of an encoded behavior sample of a user that is different from the user of the mobile device. The probability distribution may be transmitted to the mobile device from a remote device that trained the behavior generator. At block 604, an artificial neural network of the behavior generator generates a synthetic behavior sample based on the vector. The artificial neural network may comprise at least a bottleneck layer, a trained decoder layer, and a trained de-convolutional layer. The vector may be input to the bottleneck layer and further processed by the trained decoder layer and also a trained de-convolutional layer to generate a synthetic behavior sample. The synthetic behavior sample may be a vector that is a different representation of the drawn vector. In an optional configuration, at block 606, the artificial neural network generates synthetic samples that vary in size.

At block 608, the mobile device tunes a model, which identifies a device user, using the generated synthetic behavior sample. The model may be a machine learning model, such as a convolutional neural network. The tuning may be performed after an initial training of the model. Alternatively, or additionally, a generated synthetic behavior sample may be used for the initial training of the model. The model is tuned and/or initially trained using training data that includes positive samples and negative samples. In an optional configuration, at block 610 the mobile device tunes the model using a behavior sample of the device user. In one configuration, the synthetic behavior sample is a negative training sample and the behavior sample is a positive training sample.

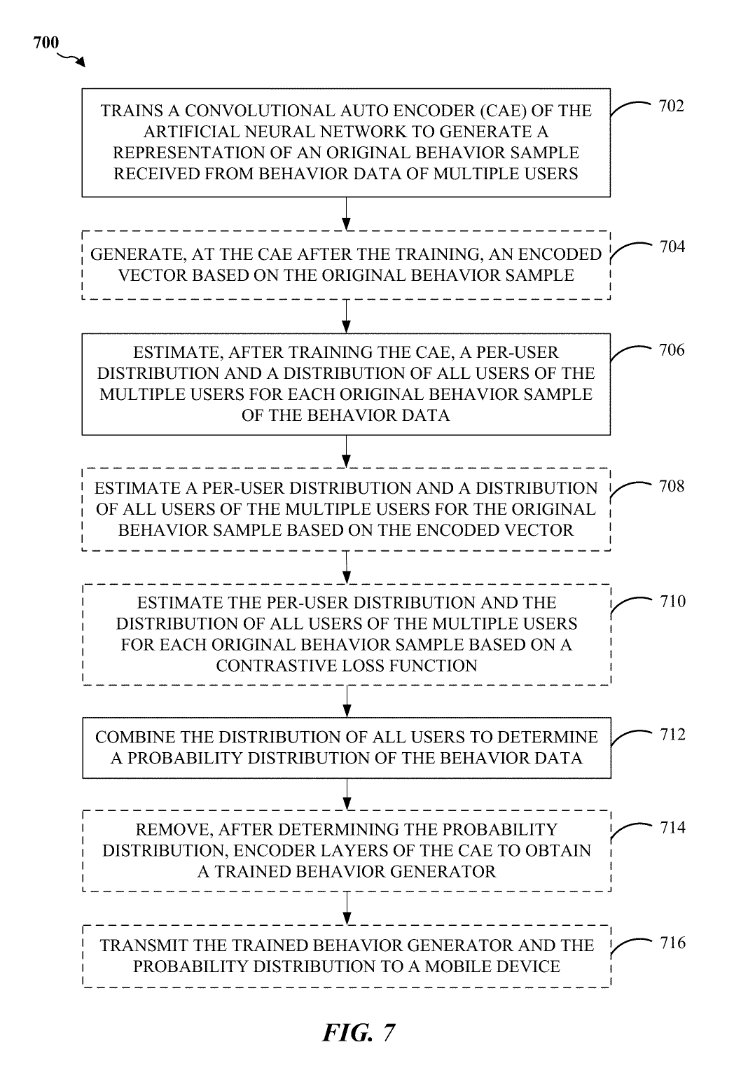

FIG. 7 illustrates a method 700 for training an artificial neural network to generate synthetic behavior samples. At block 702, the artificial neural network trains a convolutional auto encoder (CAE) of the artificial neural network to generate a representation of an original behavior sample received from behavior data of multiple users. The training may be performed by using a loss function to compare an output representation to an input representation. The loss function may generate a loss value that is back propagated to the convolutional auto encoder. The back propagation may fine tune the convolutional auto encoder until a desired loss value is obtained.

In an optional configuration, at block 704, the artificial neural network generates, at the convolutional auto encoder after the training, an encoded vector based on the original behavior sample. The encoded vector may be output from an encoder layer to a bottleneck layer. The encoded vector may be referred to as a compressed representation of an original sample representation. At block 706, the artificial neural network estimates, after training the convolutional auto encoder, a per-user distribution and a distribution of all users of the multiple users for each original behavior sample of the behavior data. In an optional configuration, at block 708, the artificial neural network estimates a per-user distribution and a distribution of all users of the multiple users for the original behavior sample based on the encoded vector.

In an optional configuration, at block 710, the artificial neural network estimates the per-user distribution and the distribution of all users of the multiple users for each original behavior sample based on a contrastive loss function. That is, a contrastive loss layer may cluster the compressed representation for the user to determine a per-user distribution and a distribution across all users. In one configuration, each compressed representation of a user is clustered closer together than compressed representations of different users. The process of clustering the compressed representation for the user to determine a per-user distribution and a distribution across all users is repeated for all samples. Additionally, the contrastive loss function may estimate the per-user distribution and the distribution of all users of the multiple users using the encoded vectors of block 708.

At block 712, the artificial neural network combines the distribution of all users to determine a probability distribution of the behavior data. In an optional configuration, at block 714, the artificial neural network removes, after determining the probability distribution, encoder layers of the convolutional auto encoder to obtain a trained behavior generator. Additionally, in an optional configuration, at block 716, the artificial neural network transmits the trained behavior generator and the probability distribution to a mobile device. The trained behavior generator may be used to generate synthetic behavior samples by drawing vectors form the probability distribution. The synthetic behavior samples may be negative samples for training data used to train and/or tune a model specified to authenticate a user of the mobile device.

In some aspects, the methods 600 and 700 may be performed by the SOC 100 (FIG. 1) or the system 200 (FIG. 2). That is, each of the elements of the methods 600 and 700 may, for example, but without limitation, be performed by the SOC 100, the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for generating synthetic behavior samples with a behavior generator, comprising:
drawing, at the behavior generator, a vector from a probability distribution obtained from behavior data of a plurality of users;
generating, with an artificial neural network (ANN) decoder of the behavior generator, a synthetic behavior sample based on the vector; and
tuning a model, which identifies a device user, using the generated synthetic behavior sample.

2. The method of claim 1, in which the generating comprises generating synthetic samples of varying size.

3. The method of claim 1, further comprising tuning the model using a behavior sample of the device user, in which the synthetic behavior sample is a negative training sample and the behavior sample is a positive training sample.

4. The method of claim 1, in which the vector comprises an encoded representation of behavior data.

5. The method of claim 1, in which the plurality of users are different from the device user.

6. A method for training an artificial neural network (ANN) to generate synthetic behavior samples, comprising:
training a convolutional auto encoder (CAE) of the ANN to generate a representation of an original behavior sample received from behavior data of a plurality of users;
estimating, after training the CAE, a per-user distribution and a distribution of all users of the plurality of users for each original behavior sample of the behavior data; and
combining the distribution of all users to determine a probability distribution of the behavior data.

7. The method of claim 6, further comprising generating, at the CAE after the training, an encoded vector based on the original behavior sample.

8. The method of claim 7, further comprising estimating the per-user distribution and the distribution of all users of the plurality of users for the original behavior sample based on the encoded vector.

9. The method of claim 6, further comprising estimating the per-user distribution and the distribution of all users of the plurality of users for each original behavior sample based on a contrastive loss function.

10. The method of claim 6, further comprising:
removing, after determining the probability distribution, encoder layers of the CAE to obtain a trained behavior generator; and
transmitting the trained behavior generator and the probability distribution to a mobile device.

11. A behavior generator for generating synthetic behavior samples, the behavior generator comprising:
a memory unit; and
at least one processor coupled to the memory unit, the at least one processor configured:
to draw a vector from a probability distribution obtained from behavior data of a plurality of users;
to generate, with an artificial neural network (ANN) decoder of the behavior generator, a synthetic behavior sample based on the vector; and
to tune a model, which identifies a device user, using the generated synthetic behavior sample.

12. The behavior generator of claim 11, in which the at least one processor is further configured to generate synthetic samples of varying size.

13. The behavior generator of claim 11, in which the at least one processor is further configured to tune the model using a behavior sample of the device user, in which the synthetic behavior sample is a negative training sample and the behavior sample is a positive training sample.

14. The behavior generator of claim 11, in which the vector comprises an encoded representation of behavior data.

15. The behavior generator of claim 11, in which the plurality of users are different from the device user.

16. An artificial neural network (ANN) for generating synthetic behavior samples, the ANN comprising:
a memory unit; and
at least one processor coupled to the memory unit, the at least one processor configured:
to train, a convolutional auto encoder (CAE) of the ANN, to generate a representation of an original behavior sample received from behavior data of a plurality of users;
to estimate, after training the CAE, a per-user distribution and a distribution of all users of the plurality of users for each original behavior sample of the behavior data; and
to combine the distribution of all users to determine a probability distribution of the behavior data.

17. The ANN of claim 16, in which the at least one processor is further configured to generate, at the CAE after the training, an encoded vector based on the original behavior sample.

18. The ANN of claim 17, in which the at least one processor is further configured to estimate the per-user distribution and the distribution of all users of the plurality of users for the original behavior sample based on the encoded vector.

19. The ANN of claim 16, in which the at least one processor is further configured to estimate the per-user distribution and the distribution of all users of the plurality of users for each original behavior sample based on a contrastive loss function.

20. The ANN of claim 16, in which the at least one processor is further configured:
to remove, after determining the probability distribution, encoder layers of the CAE to obtain a trained behavior generator; and
to transmit the trained behavior generator and the probability distribution to a mobile device.
